(19) United States
(12) Patent Application Publication
(10) Pub. No.: US 2025/0179312 A1
(43) Pub. Date: Jun. 5, 2025

(54) Paint Composition, Coating Material, Coating Layer-Provided Substrate, and Method for Manufacturing Coating Layer-Provided Substrate

(71) Applicant: VALQUA, LTD., Tokyo (JP)

(72) Inventor: Eiji Funabashi, Tochigi (JP)

(21) Appl. No.: 18/842,822

(22) PCT Filed: Feb. 27, 2023
(86) PCT No.: PCT/JP2023/006985

§ 371 Date: Aug. 30, 2024

(30) Foreign Application Priority Data
Mar. 3, 2022 (JP) 2022-032855

(51) Int. Cl. C09D 5/18; C08J 7/04; C09D 7/40; C09D 7/62; C09D 7/63; C09D 175/02

(52) U.S. Cl. CPC C09D 5/18; C08J 7/042; C09D 7/62; C09D 7/63; C09D 7/70; C09D 175/02; C08J 2327/06; C08J 2475/02

(57) ABSTRACT

Provided is a paint composition including an isocyanate component, an amine component, and a refractory agent, the isocyanate component including an aliphatic polyisocyanate, the amine component including at least one polyamine (a) selected from the group consisting of a dimethylthiotoluenediamine, a diaminodiphenylmethane, and an aspartic ester amine.

### CROSS-REFERENCE TO RELATED APPLICATIONS

This application is the United States national phase of International Patent Application No. PCT/JP2023/006985 filed Feb. 27, 2023, and claims priority to Japanese Patent Application No. 2022-032855 filed Mar. 3, 2022, the disclosures of which are hereby incorporated by reference in their entireties.

### BACKGROUND OF THE INVENTION

### Field of the Invention

The present invention relates to a paint composition, a coating material, a coating layer-provided substrate, and a method for manufacturing the coating layer-provided substrate.

### Description of Related Art

Thermoplastic resins such as polyvinyl chloride, polystyrene, an acrylic resin, polyethylene, and polypropylene, which are inexpensive and excellent in processability and moldability, are used as shaped articles in various fields such as fields of facility pipes, drain pipes, drain basins, drain lids, electrical wire pipes, and joints.

However, thermoplastic resin shaped articles are poor in impact resistance, and are likely to suffer a crack or breakage under a stress. Furthermore, thermoplastic resin shaped articles have problems such as poor fire resistance and poor weather resistance easily leading to whitening and deterioration due to ultraviolet rays.

Patent Literature 1 (i.e., JP 2002-254576 A) proposes a vinyl chloride resin pipe including a vinyl chloride resin pipe body having an outer periphery covered with an outer layer that includes an acryl-vinyl chloride-based copolymer resin composition obtained by graft polymerization of a vinyl chloride monomer to an acryl-based copolymer and has a thickness of 20 to 200 μm, for the purpose of improving weather resistance.

Patent Literature 2 (i.e., JP 4800815 B2) proposes a resin pipe in which the outer periphery of the pipe body including a vinyl chloride polymer is covered with an outer layer including an acrylonitrile/ethylene propylene rubber/styrene copolymer (AES resin) and the thickness of the outer layer is set to 0.2 to 0.4 mm, for the purpose of improving weather resistance.

Patent Literature 3 (i.e., JP 2008-180068 A) proposes a piping material for building that includes a refractory resin composition including a polyvinyl chloride-based resin containing thermally expandable graphite at a compounding ratio such that the amount of the thermally expandable graphite is 1 to 10 parts by weight with respect to 100 parts by weight of the polyvinyl chloride-based resin, from the viewpoint of fireproofness and workability.

In constant, polyurea resins are a curable resin compound based on a urea bond generated by a chemical reaction between an isocyanate and a polyamine, and are excellent in, for example, impact resistance, waterproofness, chemical resistance, abrasion resistance, heat resistance, and corrosion resistance. Furthermore, the hardness and the elongation can be freely adjusted by selecting a combination of an isocyanate and an amine.

A polyurea resin usually covers a substrate with a method in which an isocyanate and an amine are applied using a collision mixing spray machine while heated. With this method, a cured product is obtained in several seconds to several minutes after application. Thus, this method is effective in the case of covering a large surface (for example, a rooftop, an underground pit inner surface, or a tunnel wall surface) in a short time.

### SUMMARY OF THE INVENTION

### Technical Problem

However, the techniques proposed in Patent Literatures 1 to 3 have room for further improvement in imparting impact resistance and fire resistance performance to, for example, a pipe including a thermoplastic resin such as a polyvinyl chloride resin.

Furthermore, coating with a polyurea resin using a collision mixing spray machine causes problems such as nonuniform mixing of the paint and clogging of the nozzle tip unless the discharge pressure is large. However, if a polyurea paint is sprayed at once at a large discharge pressure on a substrate having a relatively small area such as a pipe, only a small amount of the paint is effectively adhered to the substrate, resulting in disposal of most of the paint, and adjustment of the coating film thickness is difficult particularly in the case of forming a thin coating film (for example, having a thickness of 1 mm or less) without unevenness.

Therefore, an object of the present invention is to provide, for example, a paint composition and a coating material that can impart impact resistance and fire resistance performance to a substrate such as a pipe including a thermoplastic resin such as a polyvinyl chloride resin without difficulty in coating operation.

### Solution to Problem

The present invention relates to, for example, the following items [1] to [16].

[1]

A paint composition including:
an isocyanate component, an amine component, and a refractory agent,
the isocyanate component including an aliphatic polyisocyanate,
the amine component including at least one polyamine (a) selected from the group consisting of a dimethylthiotoluenediamine, a diaminodiphenylmethane, and an aspartic ester amine.

[2]

The paint composition of the item [1], wherein the refractory agent includes a mixture, the mixture including a microcapsule including an ammonium polyphosphate powder coated with a resin, a melamine compound powder, and a pentaerythritol compound powder.

[3]

The paint composition of the item [1] or [2], including at least one heat shielding agent selected from the group consisting of hollow ceramic particles and a white pigment.

[4]

The paint composition of any one of the items [1] to [3], including a solvent.

[5]

A coating material including:
a polyurea that is a reaction product of an isocyanate component and an amine component, and a refractory agent,
the isocyanate component including an aliphatic polyisocyanate,
the amine component including a polyamine (a) that is at least one selected from the group consisting of a dimethylthiotoluenediamine, a diaminodiphenylmethane, and an aspartic ester amine.

[6]

The coating material of the item [5], wherein the coating material is a cured product of the paint composition of any of the items [1] to [4].

[7]

A coating layer-provided substrate including: a substrate; and a coating layer covering the substrate, the coating layer made of the coating material of the item [5] or [6].

[8]

The coating layer-provided substrate of the item [7], wherein the substrate and the coating layer are in contact with each other via an undercoat layer.

[9]

The coating layer-provided substrate of the item [7] or [8], wherein the substrate is a shaped article of a thermoplastic resin.

[10]

The coating layer-provided substrate of the item [9], wherein the thermoplastic resin is polyvinyl chloride.

[11]

The coating layer-provided substrate of the item [9] or [10], wherein the substrate is a facility pipe, a drain pipe, a drain basin, a drain lid, an electrical wire pipe, or a joint.

A method for manufacturing a coating layer-provided substrate, the method including a step of applying the paint composition of any one of the items [1] to [4] to a substrate and curing the paint composition to form a coating layer.

[13]

A method for manufacturing a coating layer-provided substrate, the method including:
a step of forming an undercoat layer on a substrate; and
a step of applying the paint composition of any one of the items [1] to [4] to the undercoat layer and curing the paint composition to form a coating layer.

[14]

The method for manufacturing a coating layer-provided substrate of the item or [13], wherein the substrate is a shaped article of a thermoplastic resin.

[15]

The method for manufacturing a coating layer-provided substrate of the item [14], wherein the thermoplastic resin is polyvinyl chloride.

[16]

The method for manufacturing a coating layer-provided substrate of the item or [15], wherein the substrate is a facility pipe, a drain pipe, a drain basin, a drain lid, an electrical wire pipe, or a joint.

### Advantageous Effects of Invention

The paint composition of the present invention, for example, can impart impact resistance and fire resistance performance to a substrate such as a pipe including a thermoplastic resin such as a polyvinyl chloride resin without difficulty in coating operation.

### DESCRIPTION OF THE INVENTION

Hereinafter, the present invention will be described in more detail.

### [Paint Composition]

The paint composition according to the present invention includes an isocyanate component, an amine component, and a refractory agent.

### <Isocyanate Component>

The isocyanate component includes an aliphatic polyisocyanate. Aliphatic polyisocyanates have high stability to ultraviolet rays, and a polyurea resin where an aliphatic isocyanate is used as a raw material isocyanate is less likely to oxidize or deteriorate (that is, more excellent in weather resistance) than a polyurea resin where an aromatic isocyanate is used as a raw material isocyanate. Therefore, the coating material formed from the paint composition of the present invention is extremely effective for coating of articles used particularly outdoors.

Examples of the aliphatic polyisocyanate include tetramethylene diisocyanate, pentamethylene diisocyanate, hexamethylene diisocyanate, octamethylene diisocyanate, dodecamethylene diisocyanate, and isophorone diisocyanate.

These may form a multimer such as a dimer.

Examples of a commercially available product of the aliphatic polyisocyanate include Desmodur (registered trademark) N 3400, N 3900, XP 2840, XP 2860, and E 2863 XP manufactured by Covestro AG.

The aliphatic polyisocyanates may be used singly, or in combination of two or more kinds thereof.

The isocyanate component may or may not contain a small amount (5 mass % or less or 1 mass % or less in the isocyanate component) of a monoisocyanate or an aromatic polyisocyanate as long as an effect of the present invention is not impaired.

### <Amine Component>

The amine component includes at least one polyamine (a) selected from the group consisting of a dimethylthiotoluenediamine (DMTDA), a diaminodiphenylmethane, and an aspartic ester amine.

The polyamines (a) may be used singly, or in combination of two or more kinds thereof.

A typical structural formula of a dimethylthiotoluenediamine is as follows.

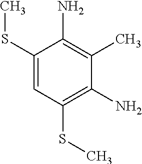

Examples of the dimethylthiotoluenediamine include 2-methyl-4,6-bis(methylsulfanyl)-1,3-benzenediamine and 4-methyl-2,6-bis(methylsulfanyl)-1,3-benzenediamine. The dimethylthiotoluenediamine may be modified as long as an effect of the present invention is not impaired.

The dimethylthiotoluenediamine may be used singly, or in combination of two or more kinds thereof.

A typical structural formula of a diaminodiphenylmethane is as follows.

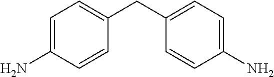 [SMILES: Nc1ccc(Cc2ccc(N)cc2)cc1]

(4,4′-Diaminodiphenylmethane)

Examples of the diaminodiphenylmethane other than 4,4′-diaminodiphenylmethane include 3,3′-diaminodiphenylmethane and 3,4′-diaminodiphenylmethane.

The diaminodiphenylmethane may be used singly, or in combination of two or more kinds thereof.

A typical structural formula of an aspartic ester amine is as follows.

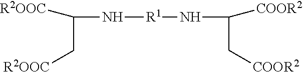

R¹ is preferably a linear, branched, or cyclic aliphatic group (preferably having 1 to 40 carbon atoms), and is more preferably selected from the group of divalent hydrocarbon groups obtained by removing amino groups from 1,4-diaminobutane, 1,5-diamino-2-methylpentane, 1,6-diaminohexane, 2,2,4-trimethyl-1,6-diaminohexane, 2,4,4-trimethyl-1,6-diaminohexane, 1-amino-3,3,5-trimethyl-5-aminomethyl-cyclohexane, 4,4′-diamino-dicyclohexylmethane, or 3,3-dimethyl-4,4′-diamino-dicyclohexylmethane.

Examples of R² include an alkyl group having 1 to 20 (preferably 1 to 8 and more preferably 1 to 4) carbon atoms (for example, a methyl group, an ethyl group, a n-propyl group, an isopropyl group, a n-butyl group, and a t-butyl group). R²s may be the same as or different from each other.

The aspartic ester amine may be modified as long as an effect of the present invention is not impaired.

The aspartic ester amine may be used singly, or in combination of two or more kinds thereof.

Examples of a commercially available product of the polyamine (a) include Desmophen (registered trademark) NH 1220, NH 1420, NH 1520, NH 1723 LF, and NH 2850 XP manufactured by Covestro AG.

Most aliphatic amines react with an isocyanate rapidly, for example, within a few seconds, whereas the polyamine (a) reacts with an isocyanate relatively slowly. Therefore, the paint composition according to the present invention containing the polyamine (a) enables adjustment of the curing time of the polyurea resin excellent in weather resistance, and in addition, appropriate setting of the properties such as the hardness, the elongation, and the viscosity.

Therefore, the paint composition of the present invention can be easily applied with, for example, a brush, a roller, or a general-purpose airless spray, and furthermore, can coat a shaped article having a complicated shape and a fine shaped article.

The amine component may or may not contain a small amount (5 mass % or less or 1 mass % or less in the amine component) of a monoamine or a polyamine other than the polyamine (a) as long as an effect of the present invention is not impaired.

The amine component may contain a fumaric acid diethyl ester modified product as long as an effect of the present invention is not impaired.

The amine component is usually used in a ratio such that the molar ratio of amino groups in the amine component to NCO groups in the isocyanate component (amino groups/NCO groups) is 1.

### <Refractory Agent>

A preferred example of the refractory agent is a mixture of a microcapsule including ammonium polyphosphate coated with a resin, a melamine compound powder, and a pentaerythritol compound powder (hereinafter, also referred to as “refractory agent mixture 1”).

Ammonium polyphosphate dehydrates and carbonizes an organic substance in a heated environment to form a fireproof carbonized layer, and ammonium polyphosphate itself also forms a fireproof inorganic phosphate film. Furthermore, ammonium polyphosphate also functions as a foaming agent that decomposes by heating to generate an ammonia gas to expand an organic substance.

The method for microencapsulating ammonium polyphosphate is not particularly limited, and for example, the method described in the paragraph of JP 4809924 B1 can be adopted.

The resin that coats ammonium polyphosphate is not particularly limited. The resin preferably forms a coating film that is less likely to be permeated by water and is excellent in water resistance, and examples of the resin include a melamine resin. The resins may be used singly, or in combination of two or more kinds thereof.

The melamine resin is a condensation product of an aldehyde, particularly formaldehyde, with melamine or its derivative. The melamine resin may be fully or partially etherified with an alkanol including 1 to 6 carbon atoms.

The average particle size (average particle size measured with a laser diffraction/scattering method, the same applies hereinafter) of the microcapsule is not particularly limited, and is preferably 60 to 120 μm.

Ammonium polyphosphate is represented by (NH₄)ₙ₊₂PnO₃ₙ₊₁, wherein n is an integer of 2 or more.

Examples of the melamine compound include melamine and its derivatives, and resins thereof, and examples of the melamine derivatives include melam, melem, melon, benzoguanamine, melamine sulfate, melamine cyanurate, and melamine polyphosphate.

The average particle size of the melamine compound powder is not particularly limited, and is preferably 60 to 120 μm.

Examples of the pentaerythritol compound include pentaerythritol and polypentaerythritols (such as dipentaerythritol and tripentaerythritol) that are condensates of pentaerythritol.

The average particle size of the pentaerythritol compound powder is not particularly limited, and is preferably 60 to 120 μm.

The mass ratio between the components in the refractory agent mixture 1 (mass of ammonium polyphosphate: mass of melamine compound powder: mass of pentaerythritol compound powder) is preferably 1:0.1 to 1.0:0.1 to 0.8.

The content of the refractory agent is preferably 10 to 60 parts by mass and more preferably 20 to 50 parts by mass with respect to 100 parts by mass of the polyurea resin produced by a reaction between the isocyanate component and the amine component.

### <Heat Shielding Agent>

The paint composition according to the present invention may contain a heat shielding agent. Examples of the heat shielding agent include hollow ceramic particles and a white pigment.

Examples of the ceramics included in the hollow ceramic particles include silica, silica-alumina, and alumina, and among these, silica is preferable from the viewpoint of reflection and radiation of solar energy and conversion of solar energy into kinetic energy.

Examples of the components included in the white pigment include titanium oxide, zinc oxide, and calcium oxide, and among these, titanium oxide is preferable because it has a low environmental load and a high photocatalytic function.

These may be used singly or in combination of two or more kinds thereof, and combination use of the hollow ceramic particle and the white pigment is preferable. In the case of combination use of the hollow ceramic particle and the white pigment, the mass ratio therebetween (mass of hollow ceramic particle:mass of white pigment) is preferably 20:1 to 30.

The content of the heat shielding agent is preferably 5 to 80 parts by mass and more preferably 10 to 50 parts by mass with respect to 100 parts by mass of the polyurea resin produced by a reaction between the isocyanate component and the amine component.

### <Solvent>

The paint composition according to the present invention may contain a solvent. Using a solvent enables further meticulous adjustment of the curing time of the paint composition according to the present invention in a reaction between the isocyanate component and the amine component and the viscosity of the paint composition.

Examples of the solvent include alcohols, ketones, ethers, and esters.

Specific examples of the alcohols include methanol, ethanol, butanol, isobutanol, isopropyl alcohol, normal propyl alcohol, and tertiary butanol.

Specific examples of the ketones include acetone, methyl ethyl ketone, diethyl ketone, methyl propyl ketone, methyl isobutyl ketone, methyl amyl ketone, cyclohexanone, isophorone, acetophenone, and benzophenone.

Specific examples of the ethers include dimethyl ether, ethyl methyl ether, diethyl ether, diphenyl ether, ethylene oxide, tetrahydrofuran, furan, 1,4-dioxane, anisole, benzofuran, dibenzofuran, and crown ether.

Specific examples of the esters include ethyl acetate, butyl acetate, methoxybutyl acetate, amyl acetate, normal propyl acetate, and isopropyl acetate.

These solvents may be used singly, or in combination of two or more kinds thereof.

### <Additive>

The function of the paint composition of the present invention can be further improved by adding various additives.

Specific examples of the additives include plasticizers, dispersants, anti-settling agents, leveling agents, thickeners, antifoaming agents, desiccants, anti-sagging agents, and matting agents.

These additives may be used singly, or in combination of two or more kinds thereof.

### [Coating Material and Coating Layer-Provided Substrate]

The coating material according to the present invention includes a polyurea that is a reaction product of the isocyanate component and the amine component, and a refractory agent, and is preferably a cured product of the above-described paint composition according to the present invention.

The coating layer-provided substrate according to the present invention includes a substrate and a coating layer covering the substrate, and the coating layer includes the above-described coating material according to the present invention.

### <Substrate>

The coating material according to the present invention is particularly effective for coating a substrate including a thermoplastic resin shaped article.

Examples of the thermoplastic resin include polyvinyl chloride, polystyrene, an acrylic resin, polyethylene, and polypropylene, and polyvinyl chloride is particularly preferable.

Examples of the substrate include facility pipes, drain pipes, drain basins, drain lids, electrical wire pipes, and joints, and among these shaped articles, those made using polyvinyl chloride are particularly preferable. These substrates are used in large amounts in the fields of supporting social infrastructures, and are desired to improve in, for example, impact resistance and fire resistance.

Furthermore, in the case of deterioration of an existing pipe in, for example, a factory or a facility, replacement of the pipe with a new pipe requires stopping the operation of the factory or the facility to cause not only replacement cost but also damage due to the stop of the operation. However, if the deteriorated existing pipe is coated with the coating material according to the present invention by, for example, coating the deteriorated existing pipe as a substrate with the paint composition according to the present invention, impact resistance and fire resistance performance can be imparted to the deteriorated existing pipe without stopping the operation of the factory or the facility.

Examples of the substrate further include floors, columns, beams, walls, and roofs of structures.

### <Undercoat Layer>

In the coating layer-provided substrate, the substrate and the coating layer are preferably in contact with each other via an undercoat layer.

The undercoat layer is provided, for example, for improving adhesion between the substrate and the coating layer.

The undercoat layer is preferably formed using a water-soluble undercoat paint. A water-soluble undercoat paint is particularly preferable because it is less likely to cause problems such as erosion and dissolution of the substrate and elution of a component in the substrate.

Specific examples of the water-soluble undercoat paint include epoxy resin emulsions, acrylic resin emulsions, cationic acrylic silicon resins, and emulsions obtained by chemically treating cellulose.

These may be used singly, or in combination of two or more kinds thereof. The undercoat paint may contain, for example, a leveling agent, a thickener, and an antifoaming agent as necessary.

The undercoat layer can be formed by applying the undercoat paint onto the substrate, and drying and curing the formed coating film.

### (Method for Manufacturing Coating Layer-Provided Substrate)

The method for manufacturing a coating layer-provided substrate according to the present invention includes a step of applying the paint composition according to the present invention to a substrate and curing the paint composition to form a coating layer.

Alternatively, the method for manufacturing a coating layer-provided substrate according to the present invention includes a step of forming an undercoat layer on a substrate and a step of applying the paint composition according to the present invention to the undercoat layer and curing the paint composition to form a coating layer.

Examples of the method for applying the paint composition according to the present invention to the substrate or the undercoat layer include a method for applying with, for example, a brush, a roller, or a general-purpose airless spray. As described above, the paint composition according to the present invention contains, as the amine component, the polyamine (a) that reacts with the isocyanate component relatively slowly, and therefore the paint composition can be easily applied without using a machine such as a collision mixing spray.

A coating film formed from the paint composition according to the present invention is cured to form a coating layer. The curing time is, for example, 12 to 72 hours and preferably 18 to 48 hours, and the curing temperature is, for example, 0 to 40° C. and preferably near room temperature (for example, 20 to 30° C.). According to the present invention, characteristics such

as impact resistance and fire resistance can be imparted to a substrate with a simple method. These characteristics can be imparted particularly to shaped articles supporting social infrastructures and including polyvinyl chloride, and therefore the present invention contributes to solving problems such as national resilience and disaster countermeasures. In particular in a case where the substrate is, for example, an aged pipe or aged piping, the energy consumption amount and the greenhouse gas generation amount are large at the time of manufacturing a new substrate for replacement. However, the present invention extends the life of the substrate, and contributes to reduction in the energy consumption amount and the gas generation amount described above.

### EXAMPLES

Hereinafter, the present invention will be described in more detail with reference to Examples. Note that the present invention is not limited to these Examples at all.

### Manufacturing Example 1

A rigid polyvinyl chloride pipe (diameter: 100 mm, length: 1000 mm) placed outdoors for 20 years was prepared, an aqueous epoxy resin paint was applied as an undercoat paint to the outer peripheral surface of the pipe and dried over 12 hours to form an undercoat layer, and thus an undercoat layer-provided substrate was obtained.

### Example 1

The components shown in Table 1 (all of which are commercially available products, the same applies to other Examples and Comparative Examples) were mixed to prepare a paint composition for coating 1. The isocyanate component and the amine component were used in a ratio of NCO groups:amino groups=1:1 (molar ratio) (the same applies to other Examples and Comparative Example 2). The paint composition for coating 1 had a viscosity of 800 mPa·s.

TABLE 1

| | Compounding ratio |
|---|---|
| | (parts by mass) |
| Isocyanate component | 100 |
| (Desmodur N 3400, manufactured | |
| by Covestro AG) | |
| Amine component | 100 |
| (Desmophen NH 1723 LF, | |
| manufactured by Covestro AG) | |
| Ammonium polyphosphate powder | 40 |
| Melamine compound powder | 20 |
| Pentaerythritol compound powder | 10 |

The paint composition for coating 1 was applied within 30 minutes after preparation to the undercoat layer of an undercoat layer-provided substrate manufactured in Manufacturing Example 1 with a brush so as to have a thickness of 400 μm. The skin-over time of the coating film 1 formed from the paint composition for coating 1 was about 1 hour (air temperature: 23° C.). Thereafter, the coating film 1 was allowed to stand for 24 hours and thus further cured to form a coating layer, and thus a coating layer-provided substrate was obtained.

### Example 2

The components shown in Table 2 were mixed to prepare a paint composition for coating 2. The paint composition for coating 2 had a viscosity of 700 mPa·s.

TABLE 2

| | Compounding ratio |
|---|---|
| | (parts by mass) |
| Isocyanate component | 100 |
| (Desmodur E 2863 XP, | |
| manufactured by Covestro AG) | |
| Amine component | 70 |
| (Desmophen NH 1420, | |
| manufactured by Covestro AG) | |
| Amine component | 30 |
| (Desmophen NH 1723 LF, | |
| manufactured by Covestro AG) | |
| Ammonium polyphosphate powder | 40 |
| Melamine compound powder | 20 |
| Pentaerythritol compound powder | 10 |
| Hollow ceramic particle | 15 |
| Titanium oxide | 15 |

The paint composition for coating 2 was applied within 30 minutes after preparation to the undercoat layer of an undercoat layer-provided substrate manufactured in Manufacturing Example 1 with a brush so as to have a thickness of 400 μm. The skin-over time of the coating film 2 formed from the paint composition for coating 2 was about 1 hour and 30 minutes (air temperature: 23° C.). Thereafter, the coating film 2 was allowed to stand for 24 hours and thus further cured to form a coating layer, and thus a coating layer-provided substrate was obtained.

### Example 3

The components shown in Table 3 were mixed to prepare a paint composition for coating 3. The paint composition for coating 3 had a viscosity of 150 mPa·s.

TABLE 3

| | Compounding ratio |
|---|---|
| | (parts by mass) |
| Isocyanate component | 50 |
| (Desmodur N 3900, manufactured | |
| by Covestro AG) | |
| Isocyanate component | 50 |
| (Desmodur E 2863 XP, | |
| manufactured by Covestro AG) | |
| Amine component | 80 |
| (Desmophen NH 1220, | |
| manufactured by Covestro AG) | |
| Amine component | 20 |
| (Desmophen NH 1520, | |
| manufactured by Covestro AG) | |
| Ammonium polyphosphate powder | 40 |
| Melamine compound powder | 20 |
| Pentaerythritol compound powder | 10 |
| Hollow ceramic particle | 15 |
| Titanium oxide | 15 |
| Butyl acetate | 20 |
| Wet dispersant | 0.5 |

The paint composition for coating 3 was applied within 30 minutes after preparation to the undercoat layer of an undercoat layer-provided substrate manufactured in Manufacturing Example 1 with a general-purpose air spray so as to have a thickness of 400 μm. The skin-over time of the coating film 3 formed from the paint composition for coating 3 was about 2 hours (air temperature: 23° C.). Thereafter, the coating film 3 was allowed to stand for 24 hours and thus further cured to form a coating layer, and thus a coating layer-provided substrate was obtained.

### Example 4

The components shown in Table 4 were mixed to prepare a paint composition for coating 4. The paint composition for coating 4 had a viscosity of 120 mPa·s.

TABLE 4

| | Compounding ratio |
|---|---|
| | (parts by mass) |
| Isocyanate component | 50 |
| (Desmodur XP 2840, manufactured | |
| by Covestro AG) | |
| Isocyanate component | 50 |
| (Desmodur XP 2860, manufactured | |
| by Covestro AG) | |
| Amine component | 60 |
| (Desmophen NH 1220, | |
| manufactured by Covestro AG) | |
| Amine component | 40 |
| (Desmophen NH 1520, | |
| manufactured by Covestro AG) | |
| Ammonium polyphosphate powder | 40 |
| Melamine compound powder | 20 |
| Pentaerythritol compound powder | 10 |
| Hollow ceramic particle | 15 |
| Titanium oxide | 15 |
| Ethanol | 30 |
| Wet dispersant | 0.5 |
| Leveling agent | 0.5 |

The paint composition for coating 4 was applied within 30 minutes after preparation to the undercoat layer of an undercoat layer-provided substrate manufactured in Manufacturing Example 1 with a general-purpose airless spray so as to have a thickness of 400 μm. The skin-over time of the coating film 4 formed from the paint composition for coating 4 was about 2 hours (air temperature: 23° C.). Thereafter, the coating film 4 was allowed to stand for 24 hours and thus further cured to form a coating layer, and thus a coating layer-provided substrate was obtained.

### Comparative Example 1

A rigid polyvinyl chloride pipe (for convenience, described as “coating layer-provided substrate” in “Test Results” described below) placed outdoors for 20 years was prepared and subjected to no treatment.

### Comparative Example 2

100 parts by mass of the isocyanate component (Desmodur N 3400, manufactured by Covestro AG) and 100 parts by mass of the amine component (Desmophen NH 1723 LF, manufactured by Covestro AG) were mixed to prepare a paint composition for coating c2. The paint composition for coating c2 had a viscosity of 400 mPa·s.

The paint composition for coating c2 was applied within 30 minutes after preparation to the undercoat layer of an undercoat layer-provided substrate manufactured in Manufacturing Example 1 with a brush so as to have a thickness of 400 μm, and then allowed to stand for 24 hours and thus further cured to form a coating layer, and thus a coating layer-provided substrate was obtained.

### Comparative Example 3

100 parts by mass of an AES resin (UNIBRITE (registered trademark) UA-1500, manufactured by NIPPON A&L INC.) and 500 parts by mass of a solvent (methyl ethyl ketone) were mixed to prepare a paint composition for coating c3.

The paint composition for coating c3 was applied within 30 minutes after preparation to the undercoat layer of an undercoat layer-provided substrate manufactured in Manufacturing Example 1 so as to have a thickness of 400 μm, and allowed to stand for 24 hours and thus further cured to form a coating layer, and thus a coating layer-provided substrate was obtained.

### [Test Results]

The following tests were performed using the coating layer-provided substrates obtained in Examples and Comparative Examples as test bodies.

### [Test 1. Impact Resistance]

An iron ball having a weight of 2 kg was naturally dropped from a height of 1 m on the outer peripheral surface of a fixed test body, and the damage state of the test body was visually observed.

### [Test 2. Fire Resistance]

A gas burner was placed at a position of 10 cm from the outer peripheral surface of a fixed test body, a flame having a temperature of 1200° C. was directly applied to the outer peripheral surface of the test body, and the burning state was visually observed.

### [Test 3. Heat Shielding Property]

A test body was fixed in a thermostatic bath at a temperature of 23° C., a 1500 W xenon lamp was placed at a position of 30 cm in height from the test body, the test body was irradiated with light, and the temperature of the test body after 1 hour was measured.

TABLE 5

| | Test 1 • impact | Test 2 • fire | Test 3 • heat |
|---|---|---|---|
| | resistance | resistance | shielding property |
| Example 1 | No breakage and | Only carbonization | 32° C. |
| | no crack | without spreading | |
| | | of flames | |
| Example 2 | No breakage and | Only carbonization | 27° C. |
| | no crack | without spreading | |
| | | of flames | |
| Example 3 | No breakage and | Only carbonization | 27° C. |
| | no crack | without spreading | |
| | | of flames | |
| Example 4 | No breakage and | Only carbonization | 27° C. |
| | no crack | without spreading | |
| | | of flames | |
| Comparative | Breakage into | Gradual spreading | 35° C. |
| Example 1 | pieces | of flames and | |
| | | dissolution | |
| Comparative | No breakage and | Spreading of flames | 32° C. |
| Example 2 | no crack | in several seconds | |
| Comparative | No breakage and | Gradual spreading | 35° C. |
| Example 3 | no crack | of flames and | |
| | | dissolution | |

1. (canceled)

2. (canceled)

3. (canceled)

4. (canceled)

5. (canceled)

6. (canceled)

7. (canceled)

8. (canceled)

9. (canceled)

10. (canceled)

11. A coating layer-provided substrate, comprising a substrate, and a coating layer covering the substrate,
wherein the coating layer is made of the coating material comprising:
a polyurea that is a reaction product of an isocyanate component and an amine component, and a refractory agent,
the isocyanate component comprising an aliphatic polyisocyanate,
the amine component comprising a polyamine (a) that is at least one selected from the group consisting of a dimethylthiotoluenediamine, a diaminodiphenylmethane, and an aspartic ester amine,
wherein the substrate is a shaped article of a thermoplastic resin, and
wherein the substrate is a facility pipe, a drain pipe, a drain basin, a drain lid, an electrical wire pipe, or a joint.

12. (canceled)

13. (canceled)

14. (canceled)

15. A method for manufacturing a coating layer-provided substrate, the method comprising:
a step of applying a paint composition to a substrate and curing the paint composition to form a coating layer, or comprising;
a step of forming an undercoat layer on a substrate, and
a step of applying a paint composition to the undercoat layer and curing the paint composition to form a coating layer,
wherein the paint composition comprises:
an isocyanate component, and amine component, and a refractory agent,
the isocyanate component comprising an aliphatic polyisocyanate,
the amine component comprising at least one polyamine (a) selected from the group consisting of a dimethylthiotoluenediamine, a diaminodiphenylmethane, and an aspartic ester amine,
wherein the substrate is a shaped article of a thermoplastic resin, and
wherein the substrate is a facility pipe, a drain pipe, a drain basin, a drain lid, an electrical wire pipe, or a joint.

16. The coating layer-provided substrate according to claim 11, wherein the refractory agent comprises a mixture, the mixture comprising a microcapsule comprising an ammonium polyphosphate powder coated with a resin, a melamine compound powder, and a pentaerythritol compound powder.

17. The coating layer-provided substrate according to claim 11, wherein the coating material comprises at least one heat shielding agent selected from the group consisting of hollow ceramic particles and a white pigment.

18. The coating layer-provided substrate according to claim 11, wherein the thermoplastic resin is polyvinyl chloride.

19. The method for manufacturing a coating layer-provided substrate according to claim 15, wherein the refractory agent comprises a mixture, the mixture comprising a microcapsule comprising an ammonium polyphosphate powder coated with a resin, a melamine compound powder, and a pentaerythritol compound powder.

20. The method for manufacturing a coating layer-provided substrate according to claim 15, wherein the paint composition comprises at least one heat shielding agent selected from the group consisting of hollow ceramic particles and a white pigment.

21. The method for manufacturing a coating layer-provided substrate according to claim 15, wherein the paint composition comprises a solvent.

22. The method for manufacturing a coating layer-provided substrate according to claim 15, wherein the thermoplastic resin is polyvinyl chloride.
